(19) United States
(12) Patent Application Publication
(10) Pub. No.: US 2026/0369637 A1
(43) Pub. Date: Nov. 19, 2026

(54) FLATNESS-BASED CONTROL SYSTEM WITH CONSIDERATION OF MANIPULATED VARIABLE LIMITATIONS

(71) Applicant: Robert Bosch GmbH, Stuttgart (DE)

(72) Inventors: Christian Dullinger, St. Pölten (AT); Thomas Bleile, Stuttgart-Zuffenhausen (DE); Alexander Metzger, Bad Vöslau (AT)

(21) Appl. No.: 19/475,241

(22) PCT Filed: Apr. 4, 2024
(86) PCT No.: PCT/EP2024/059156

§ 371 Date: Oct. 14, 2025

(30) Foreign Application Priority Data
Apr. 19, 2023 (DE) 10 2023 203 576.6

(51) Int. Cl. H01M 8/04298; F03G 7/00; H01M 8/04007; H01M 8/04701

(52) U.S. Cl. CPC H01M 8/04305; F03G 7/012; H01M 8/04067; H01M 8/04723

(57) ABSTRACT

The invention relates to a method for model-based operation, in particular control, of a controlled system (Σₚ(⋅)), preferably in the form of a subsystem of a coolant system, preferably for operating an electrochemical energy converter, comprising the following steps:
determining a state (m_{actuator}(k)) of an actuator of the controlled system (Σₚ(⋅)), taking into account manipulated variable limitations (u_{req,min}(k)/u_{req,max}(k)) of the actuator,
operating the controlled system (Σₚ(⋅)) depending on the specific state (m_{actuator}(k)) of the actuator.

### BACKGROUND

The invention relates to a method for model-based operation, in particular control, of a controlled system, preferably in the form of a subsystem of a coolant system, preferably for operating an electrochemical energy converter, for example in the form of a fuel cell system or an electrolyzer. The invention also relates to a corresponding computer program product, a corresponding controller and a corresponding electrochemical energy converter.

With known flatness-based control systems, limitations of the controllers (i.e. the actuators) are not systematically taken into account in the control concept. As a result, if the calculated manipulated variable is larger or smaller than the manipulated variable that the controller (i.e. the actuators) can provide, this is only limited subsequently, at the end of the calculation chain. However, this leads to incorrect results in the calculations of the state variables of the system model (which are stored variables in the software), which are performed before this subsequent restriction, with the error increasing over time (i.e., the state variables of the system model drift away from the system states of the controlled systems) the longer the controller remains in the manipulated variable limitations. If the controller later releases the manipulated variable limitations again, the state variables of the system model that have drifted as a result have a negative effect on the control behavior.

### SUMMARY

The present invention provides: A method for model-based operation, in particular control, of a controlled system, preferably in the form of a subsystem of a coolant system, preferably for operating an electrochemical energy converter, for example in the form of a fuel cell system or an electrolyzer, with the features of the independent method claim. In addition, the invention provides: A corresponding computer program, a corresponding controller, and a corresponding energy converter with the features of the appended claims. In this context, features and details described in connection with the various embodiments and/or aspects of the invention clearly also apply in connection with the other embodiments and/or aspects of the invention, and respectively vice versa, so, with respect to the disclosure, mutual reference to the individual embodiments and/or aspects of the invention is or can always be made.

The present invention provides, according to the first aspect: a method (hereinafter also referred to as a control method) for model-based operation, in particular control, of a controlled system, preferably in the form of a subsystem of a coolant system, preferably for operating an electrochemical energy converter, for example in the form of a fuel cell system or an electrolyzer.

The method comprises the following method steps/actions:
determining a state m_{actuator}(k) of an actuator of the controlled system Σₚ(⋅), taking into account manipulated variable limitations u_{req,min}(k)/u_{req,max}(k) of the actuator,
operating the controlled system Σₚ(⋅) depending on the specific state m_{actuator}(k) of the actuator.

In this way, a flatness-based control concept can be provided in which the limitations of the controllers (i.e. the actuators) are systematically taken into account in the control concept. In an advantageous way, this control concept can be applied to the components of a coolant circuit of an electrolyzer.

An actuator within the scope of the invention can, for example, have a pump, a valve, etc.

The control method can be used in an advantageous way with different controlled systems Σₚ(⋅) and/or different system models. Σₘ(⋅)

A coolant system can be understood as any temperature control system that uses a cooling fluid or coolant to enable the temperature control of an electrochemical energy converter, particularly in the form of a fuel cell stack of a fuel cell system or an electrolyzer.

The coolant may generally be referred to as a tempering agent.

In some modes of operation of the fuel cell system, such as for a freeze start and/or a cold start, the coolant system may serve to warm the fuel cell stack to appropriate operating temperatures. In turn, in other modes of operation of the fuel cell system, such as during normal operation, high-load operation, etc., the coolant system may serve to cool the fuel cell stack to appropriate operating temperatures.

A coolant system within the scope of the present disclosure may include a coolant pump for circulating the coolant. In addition, the coolant system may have a cooler bypass valve (a so-called mixing point of the coolant system, e.g. in the form of a three-way valve) to direct part of the coolant through the cooler (e.g. radiator) and/or another part past the cooler.

A controlled system Σₚ(⋅) of the coolant system can, for example, be a mixing point in which the coolant of the cooler path mixes with the coolant of the bypass path.

A controlled system Σₚ(⋅) of the coolant system can, for example, be a coolant path through a fuel cell stack of the fuel cell system.

A controlled system Σₚ(⋅) of the coolant system can, for example, be a coolant path through a cooler.

Advantageously, a limited setpoint y_{set,lim}(k) can be calculated based on a limited manipulated variable uₗᵢₘ(k) (i.e., the respective saturation value of the manipulated variable), the model equations of the system model and an inverted trajectory generator Σ(⋅) when the controller (i.e., actuator) is currently in saturation (i.e., in a limited mode). The limited setpoint y_{set,lim}(k) can mean which setpoint is reached with the limited manipulated variable uₗᵢₘ(k) (e.g., with a maximum value of the manipulated variable u_{req,max}(k)). A switching device can be provided which can be specifically designed to decide, preferably based on a comparison of the limited setpoint y_{set,lim}(k) with the setpoint yₛₑₜ(k), when the limited mode can be exited and a non-limited mode can be switched to. Furthermore, the switching device can be specially designed to decide, preferably based on a comparison of the requested manipulated variable u_{req}(k) with its maximum value u_{req,max}(k) or its minimum value u_{req,min}(k), when to switch from the non-limited mode to the limited mode. In non-limited mode, the calculation is different from that in limited mode.

This approach allows systematic consideration of manipulated variable limitations in the flatness-based control concept. This prevents drifted state variables of the system model when the controller is or was in saturation.

Another advantage relating to a specific application example in a fuel cell stack can be provided as described below. For fuel cell stacks, the requirement is that the coolant inlet temperature and the coolant differential temperature (i.e., the difference between the coolant outlet temperature and the coolant inlet temperature) must be regulated. Since the coolant differential temperature is not a flat output, the requirement to control the coolant differential temperature cannot be achieved directly with a flatness-based control concept. Therefore, it is advantageously proposed that instead of the coolant differential temperature, the coolant outlet temperature is selected as the control variable and a setpoint signal for the coolant outlet temperature of the fuel cell stack is calculated based on the setpoint signal or the limited setpoint signal of the coolant inlet temperature and the setpoint signal of the coolant differential temperature.

Furthermore, it may be provided that at least two modes for operating the controlled system Σₚ(⋅) are provided depending on the specific state m_{actuator}(k) of the actuator:
a non-limited (or free) mode m_{actuator,free}, in which the actuator can provide a requested manipulated variable u_{req}(k) without restriction,
a limited mode m_{actuator,min}/m_{actuator,max} in which the actuator can provide a requested manipulated variable u_{req}(k) restricted by at least one manipulated variable limitation u_{req,min}(k)/u_{req,max}(k).

In the following, Σ_{m,aug}(⋅) denotes the augmented (dynamic non-linear) system model, which is obtained by augmenting the (dynamic non-linear) system model Σₘ(⋅) by feeding a requested compensation term/correction term d_{req}(k) (e.g. an additive term, a multiplicative term, etc.) into one of the equations of the model Σₘ(⋅). The requested compensation term/correction term d_{req}(k) represents the intervention caused by the controller. If the block

$${\sum }_{m , aug}^{- 1} ( \cdot )$$

is replaced by the block

$${\sum }_{m}^{- 1} ( \cdot )$$

in FIG. 1a or the block Σ_{m,aug}(⋅) is replaced by the block Σₘ(⋅) in FIG. 1b, FIG. 1 is a pure feedforward control (i.e. there is no feedback caused by a controller).

It should be noted that the controlled system Σₚ(⋅), the system model Σₘ(⋅) and the augmented system model Σ_{m,aug}(⋅) are generally represented/described by dynamic non-linear functions. The notation “(⋅)” is used to indicate that these non-linear functions depend on a plurality of input arguments, which are only mentioned for the sake of readability if this is necessary for understanding.

In the following, the notation Σ_{m,aug}(⋅) denotes the mathematical formulation of the (dynamic non-linear) augmented system model, which calculates the modeled controlled system output yₘ(k) (i.e., the value of the controlled variable y(k) calculated by the model) as a function of the manipulated variable u(k), the calculated and/or measured (and therefore known) disturbance variables zₘ(k) and the estimated deviation term/error term d(k), i.e.:

yₘ=Σ_{m,aug}(u,zₘ,d).

The notation

$${\sum }_{m , aug}^{- 1} ( \cdot )$$

denotes the formulation that calculates the manipulated variable u(k) as a function of the estimated deviation term/error term d(k), the calculated and/or measured (and therefore known) disturbance variables zₘ(k), the controlled variable y(k) and their time derivatives \dot{y}(k), ÿ(k), . . . , y⁽ⁿ⁾(k) (n is the system order of the system model Σₘ(⋅)), i.e.:

$$u = {\sum }_{m , aug}^{- 1} ( d , {z}_{m} , y , \dot{y} , … , {y}^{( n )} ) .$$

Preferably, the augmented system model Σ_{m,aug}(⋅) can be obtained by augmenting the system model Σₘ(⋅) of the controlled system Σₚ(⋅) in a model equation that models a physical power balance. This makes it possible to estimate/calculate the deviation term/error term in almost every model equation of the Σₘ(⋅) system model in an advantageous way. d(k) The deviation term/error term d(k) can advantageously extend the system model Σₘ(⋅) as an internal model variable (e.g. as an additive term, a multiplicative term, etc.).

Furthermore, it can be stipulated that the following steps are performed in the non-limited mode m_{actuator,free}.
determining a setpoint of yₛₑₜ(k) a control variable y(k),
Determination of a desired value y_{des}(k) of the controlled variable y(k) and of time derivatives \dot{y}_{des}(k), ÿ_{des}(k), . . .

$${y}_{des}^{( n )}$$

(k) of the desired value y_{des}(k) up to a system order n of an augmented system model Σ_{m,aug}(⋅) of the controlled system Σₚ(⋅) as a function of the setpoint yₛₑₜ(k) of the control variable y(k) using a trajectory generator Σ_{des}(⋅),
determining a requested manipulated variable u_{req}(k) of the actuator as a function of the desired value y_{des}(k) of the controlled variable y(k) and of time derivatives \dot{y}_{des}(k), ÿ_{des}(k), . . .

$${y}_{des}^{( n )}$$

(k) of the desired value y_{des}(k) using an inverted augmented system model

$${\sum }_{m , aug}^{- 1} ( \cdot )$$

the controlled system Σₚ(⋅),
Set a limited setpoint y_{set,lim}(k) of the controlled variable y(k) equal to the specific setpoint yₛₑₜ(k) of the controlled variable y(k).

In this case, the controller (i.e. actuator) is not in saturation. The command signal/setpoint signal yₛₑₜ(k) goes into the trajectory generator Σ_{des}(⋅) (e.g. in the event that the system order of the system model is n=1, a PT1 filter could be used as the trajectory generator). The purpose of the trajectory generator Σ_{des}(⋅) is to calculate the so-called desired controlled variable y_{des}(k) (the desired value of the controlled variable y(k)) and the time derivatives \dot{y}_{des}(k), ÿ_{des}(k), . . . ,

$${y}_{des}^{( n )}$$

(k). The desired controlled variable y_{des}(k) and its time derivatives \dot{y}_{des}(k), ÿ_{des}(k), . . .

$${y}_{des}^{( n )}$$

(k) are then entered into the

$${\sum }_{m , aug}^{- 1} ( \cdot )$$

model (instead of y(k), \dot{y}(k), ÿ (k), . . . , y⁽ⁿ⁾(k)). In addition, the known/measurable disturbance variables zₘ(k) are included in the model

$${\sum }_{m , aug}^{- 1} ( \cdot )$$

and instead of the estimated deviation term/error term d(k) a so-called requested compensation term/correction term d_{req}(k) is included in the model

$${Σ}_{m , aug}^{- 1} ( \cdot )$$

Consequently, the so-called requested manipulated variable u_{req}(k) is calculated:

$${u}_{req} = {Σ}_{m , aug}^{- 1} ( {d}_{req} , {z}_{m} , {y}_{des} , {\dot{y}}_{des} , … , {y}_{des}^{( n )} ) .$$

In addition, the so-called limited setpoint y_{set,lim}(k) is set equal to the setpoint yₛₑₜ(k). The limited setpoint y_{set,lim}(k) is required by the switching logic in a switching device that switches between the calculation in non-limited mode and limited mode.

Furthermore, the following steps can be performed in the limited mode m_{actuator,min}/m_{actuator,max}:
determining a limited manipulated variable uₗᵢₘ(k) of the actuator,
Determination of a desired value y_{des}(k) of the controlled variable y(k) and of time derivatives \dot{y}_{des}(k), ÿ_{des}(k), . . . ,

$${y}_{des}^{( n )}$$

(k) of the desired value y_{des}(k) up to a system order n of an augmented system model Σ_{m,aug}(⋅) of the controlled system Σₚ(⋅) as a function of the limited manipulated variable uₗᵢₘ(k) using the augmented system model Σ_{m,aug}(⋅),
determining a limited setpoint y_{set,lim}(k) of the controlled variable y(k) as a function of the desired value y_{des}(k) of the controlled variable y(k) and of time derivatives \dot{y}_{des}(k), ÿ_{des}(k), . . . ,

$${y}_{des}^{( n )}$$

(k) of the desired value y_{des}(k) using an inverted trajectory generator

$${Σ}_{des}^{- 1} ( \cdot ) ,$$

setting a requested manipulated variable u_{req}(k) of the actuator equal to the limited manipulated variable uₗᵢₘ(k).

In this case, the controller (i.e. actuator) is in saturation. Depending on whether the controller is in the upper or lower stop (i.e. in the upper or lower saturation), the corresponding value (i.e. the respective saturation value) of the manipulated variable in the upper stop (i.e. the maximum manipulated variable) u_{req,max}(k) or in the lower stop (i.e. the minimum manipulated variable) u_{req,min}(k) is fed into the model Σ_{m,aug}(⋅) as a so-called limited manipulated variable uₗᵢₘ(k). Taking into account the inverted trajectory generator

$${Σ}_{des}^{- 1} ( \cdot ) ,$$

whose inputs are the desired controlled variable y_{des}(k) and its time derivatives \dot{y}_{des}(k), ÿ_{des}(k), . . . ,

$${y}_{des}^{( n )} ( k )$$

the limited setpoint y_{set,lim}(k) is calculated. The limited setpoint y_{set,lim}(k) therefore indicates which setpoint is reached with the limited manipulated variable uₗᵢₘ(k). In addition, the requested manipulated variable u_{req}(k) is set equal to the limited manipulated variable uₗᵢₘ(k) in limited mode.

In addition, it may be provided that a switching device (may also be referred to as a state machine) is provided to switch the operation of the controlled system Σₚ(⋅) between the first mode m_{actuator,free} and the second mode m_{actuator,min}/m_{actuator,max}. On the one hand, the switching device can be used to compare a limited setpoint y_{set,lim}(k) of a controlled variable y(k) with a setpoint yₛₑₜ(k) of the controlled variable y(k) and, depending on the comparison, to determine whether the limited mode m_{actuator,min}/m_{actuator,max} can be exited and switched to the non-limited mode m_{actuator,free}. The switching device can also be used to compare a requested manipulated variable u_{req}(k) of the actuator with the manipulated variable limitations u_{req,min}(k)/u_{req,max}(k) and, depending on the comparison, to determine whether it is necessary to switch from the non-limited mode m_{actuator,free}) to the limited mode m_{actuator,min}/m_{actuator,max}.

The switching device or the state machine can determine the mode of the actuator m_{actuator}(k). The state machine can have the states “Controller in lower saturation,” “Controller not in saturation” and “Controller in upper saturation.” The state machine can start in the “Controller in lower saturation” state. In this state, the mode of the controller m_{actuator}(k) is set to m_{actuator}, min, whereby m_{actuator,min} indicates that the controller is currently in the lower saturation. As long as the state machine is in the “Controller in lower saturation” state, the condition is checked in each time step k to see whether the limited setpoint y_{set,lim}(k) is greater than the setpoint yₛₑₜ(k). As long as this condition is not met, the state machine remains in the “Controller in low saturation” state. However, as soon as this condition is met, the state machine switches to the “Controller not in saturation” state. In this state, the mode of the actuator m_{actuator}(k) is set to m_{actuator,free}, whereby m_{actuator,free} indicates that the controller is not currently in saturation. As long as the state machine is in the “Controller not in saturation” state, two conditions are checked in each time step k. If the “requested” manipulated variable u_{req}(k) is greater than or equal to its (current) maximum value u_{req,max}(k), the state machine changes to the “Controller in upper saturation” state. If the “requested” manipulated variable u_{req}(k) is less than or equal to its (current) minimum value u_{req,min}(k), the state machine switches to the “controller in lower saturation” state. If neither of the two conditions is met, the state machine remains in the “Controller not in saturation” state. In the “Controller in upper saturation” state, the mode of the actuator m_{actuator}(k) is set to m_{actuator,max}, whereby m_{actuator}, max indicates that the controller is currently in upper saturation. As long as the state machine is in the “Controller in upper saturation” state, the condition is checked in each time step k to see whether the limited setpoint y_{set,lim}(k) is smaller than the setpoint yₛₑₜ(k). As long as this condition is not met, the state machine remains in the “Controller in upper saturation” state. However, as soon as this condition is met, the state machine switches to the “Controller not in saturation” state.

On the one hand, it is conceivable that the method is used to operate, in particular control, a controlled system Σₚ(⋅) in the form of a fuel cell stack. Preferably, a coolant outlet temperature from a fuel cell stack can be used as the controlled variable y(k), in particular to control a coolant differential temperature through a fuel cell stack.

It is also conceivable that the method is used to operate, in particular control, a controlled system Σₚ(⋅) in the form of a mixing point of a coolant system. Advantageously, a coolant inlet temperature in a fuel cell stack can be used as the controlled variable y(k).

It is also conceivable that the method is used to operate, in particular control, a controlled system Σₚ(⋅) in the form of a cooler (or generally a heat exchanger) of a coolant system. Advantageously, a coolant outlet temperature from a cooler can be used as the controlled variable y(k).

The method can therefore be used to enable advantageous model-based control of a coolant system, preferably for operating an electrochemical energy converter.

Furthermore, it can be advantageous that the method can be used for operating, in particular controlling, controlled systems with several input variables and/or several manipulated variables and/or several controlled variables.

According to a further aspect, the invention provides a computer program product comprising commands that, when executed by a computer, cause the computer to perform the method that can be carried out as described above. The computer program product may be used to achieve the same advantages described above in connection with the method according to the method. Full reference is made to these advantages in the present case.

A corresponding controller provides a further aspect of the invention. A computer program in the form of a code can be stored in a memory unit of the controller which, when the code is executed by a computing unit of the controller, carries out a procedure which can run as described above. With the aid of the controller, the same advantages may be achieved as described above in connection with the method according to the invention. Full reference is made to these advantages in the present case.

A corresponding electrochemical energy converter with a corresponding controller provides a further aspect of the invention. The energy converter can be used to achieve the same advantages as described above in connection with the method according to the invention. Full reference is made to these advantages in the present case.

### BRIEF DESCRIPTION OF THE DRAWINGS

The invention and the embodiments, as well as the advantages thereof, are explained in further detail hereinafter with reference to the drawing. It shows schematically in each case:

FIG. 1a Block diagram showing the basic calculations for systematically considering constraints for a controller (i.e., actuator) not in saturation (i.e., “non-limited mode”) in the flatness-based control concept,

FIG. 1b Block diagram showing the basic calculations for systematically considering constraints for a controller (i.e., actuator) in saturation (i.e., “limited mode”) in the flatness-based control concept,

FIG. 2 a state machine that determines the mode of the actuator m_{actuator}(k) used to switch between the calculation in FIG. 1a (which is performed when the controller is not in saturation) and the calculation in FIG. 1b (which is performed when the controller is in lower or upper saturation).

### DETAILED DESCRIPTION

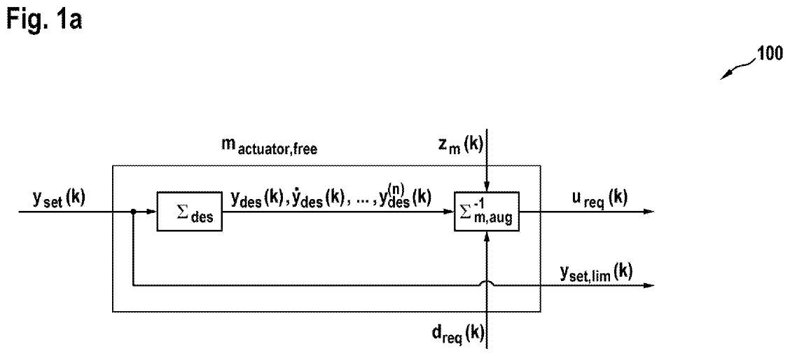

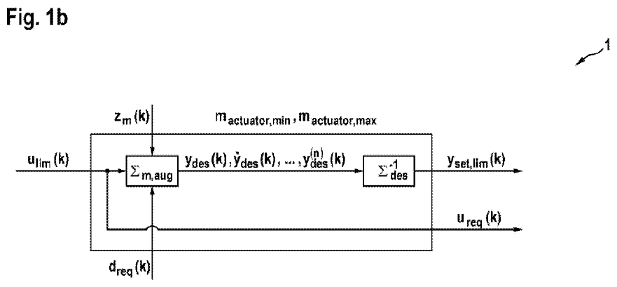

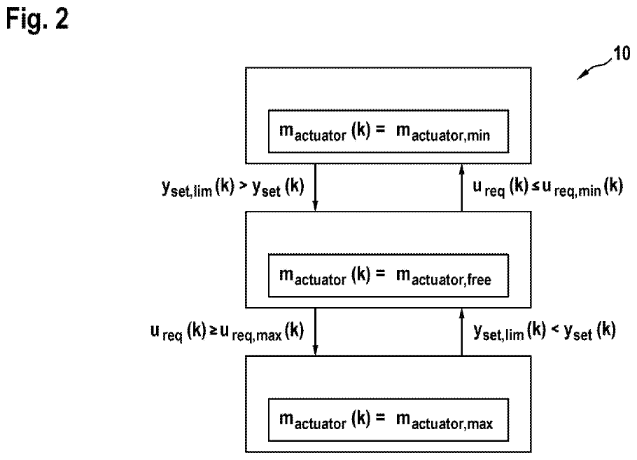

In the blocks in FIGS. 1a, 1b and 2, “(⋅)” is omitted to save space (e.g. Σₚ(⋅) is abbreviated to Σₚ).

FIGS. 1a, 1b, and 2 serve to explain a method (hereinafter also referred to as a control method) for model-based operation, in particular control, of a controlled system, preferably in the form of a subsystem of a coolant system, preferably for operating an electrochemical energy converter, e.g., in the form of a fuel cell system or an electrolyzer.

The method comprises the following method steps/actions:
determining a state m_{actuator}(k) of an actuator of the controlled system Σₚ(⋅), taking into account manipulated variable limitations u_{req,min}(k)/u_{req,max}(k) of the actuator,
operating the controlled system (Σₚ(⋅)) depending on the specific state m_{actuator}(k) of the actuator.

The method can be used to provide a flatness-based control concept in which the limitations of the controllers (i.e. the actuators) are systematically taken into account in the control concept. In an advantageous way, this control concept can be applied to the components of a coolant circuit of an electrolyzer.

An actuator within the scope of the invention can, for example, have a pump, a valve, etc.

The control method can be used in an advantageous way with different controlled systems Σₚ(⋅) and/or different system models. Σₘ(⋅)

A coolant system can be understood as any temperature control system that uses a cooling fluid or coolant to enable the temperature control of an electrochemical energy converter, particularly in the form of a fuel cell stack of a fuel cell system or an electrolyzer.

The coolant may generally be referred to as a tempering agent.

In some modes of operation of the fuel cell system, such as for a freeze start and/or a cold start, the coolant system may serve to warm the fuel cell stack to appropriate operating temperatures. In turn, in other modes of operation of the fuel cell system, such as during normal operation, high-load operation, etc., the coolant system may serve to cool the fuel cell stack to appropriate operating temperatures.

A coolant system within the scope of the present disclosure may include a coolant pump for circulating the coolant. In addition, the coolant system may have a cooler bypass valve (a so-called mixing point of the coolant system, e.g. in the form of a three-way valve) to direct part of the coolant through the cooler (e.g. radiator) and/or another part past the cooler.

A controlled system Σₚ(⋅) of the coolant system can, for example, be a mixing point in which the coolant of the cooler path mixes with the coolant of the bypass path.

A controlled system Σₚ(⋅) of the coolant system can, for example, be a coolant path through a fuel cell stack of the fuel cell system.

A controlled system Σₚ(⋅) of the coolant system can, for example, be a coolant path through a cooler.

Advantageously, a limited setpoint y_{set,lim}(k) can be calculated based on a limited manipulated variable uₗᵢₘ(k) (i.e., the respective saturation value of the manipulated variable), the model equations of the system model and a trajectory generator when the controller (i.e., actuator) is currently in saturation (i.e., in a limited mode) (see FIG. 1b). The limited setpoint y_{set,lim}(k) can mean which setpoint is reached with the limited manipulated variable uₗᵢₘ(k) (e.g., with a maximum value of the manipulated variable u_{req,max}(k)). A switching device (see FIG. 2) can be provided which can be specifically designed to decide, preferably based on a comparison of the limited setpoint y_{set,lim}(k) with the setpoint yₛₑₜ(k), when the limited mode can be exited and a non-limited mode can be switched to. Furthermore, the switching device can be specially designed to decide, preferably based on a comparison of the requested manipulated variable Urea (k) with its maximum value u_{req,max}(k) or its minimum value u_{req,min}(k), when to switch from the non-limited mode to the limited mode. In non-limited mode, a different calculation is performed (see block diagram in FIG. 1a) than in limited mode (see block diagram in FIG. 1b).

This approach allows systematic consideration of manipulated variable limitations in the flatness-based control concept. This prevents drifted state variables of the system model when the controller is or was in saturation.

Another advantage relating to a specific application example in a fuel cell stack can be provided as described below. For fuel cell stacks, the requirement is that the coolant inlet temperature and the coolant differential temperature (i.e., the difference between the coolant outlet temperature and the coolant inlet temperature) must be regulated. Since the coolant differential temperature is not a flat output, the requirement to control the coolant differential temperature cannot be achieved directly with a flatness-based control concept. Therefore, it is advantageously proposed that instead of the coolant differential temperature, the coolant outlet temperature is selected as the control variable and a setpoint signal for the coolant outlet temperature of the fuel cell stack is calculated based on the setpoint signal or the limited setpoint signal of the coolant inlet temperature and the setpoint signal of the coolant differential temperature.

As FIGS. 1a and 1b indicate, at least two modes for operating the controlled system Σₚ(⋅) can be provided depending on the specific state m_{actuator}(k) of the actuator:
a non-limited (or free) mode m_{actuator,free}, in which the actuator can provide a requested manipulated variable u_{req}(k) without restriction,
a limited mode m_{actuator,min}/m_{actuator}, max in which the actuator can provide a requested manipulated variable u_{req}(k) restricted by at least one manipulated variable limitation u_{req,min}(k)/u_{req,max}(k).

If the controller (i.e. actuator) is not currently in saturation, the calculation is performed as shown in the block diagram in FIG. 1a. However, if the controller is currently in the upper or lower stop (i.e. in the upper or lower saturation), the calculation is performed as shown in the block diagram in FIG. 1b. The switching logic that switches between the calculation in FIG. 1a and the calculation in FIG. 1b will be discussed later (see FIG. 2). The description of FIG. 1 follows first.

In the following, Σ_{m,aug}(⋅) denotes the augmented (dynamic non-linear) system model, which is obtained by augmenting the (dynamic non-linear) system model Σₘ(⋅) by feeding a requested compensation term/correction term d_{req}(k) (e.g. an additive term, a multiplicative term, etc.) into one of the equations of the model Σₘ(⋅). The requested compensation term/correction term d_{req}(k) represents the intervention caused by the controller. If the block

$${Σ}_{m , aug}^{- 1} ( \cdot )$$

is replaced by the block

$${Σ}_{m}^{- 1} ( \cdot )$$

in FIG. 1a or the block Σ_{m,aug}(⋅) is replaced by the block Σₘ(⋅) in FIG. 1b, FIG. 1 is a pure feedforward control (i.e. there is no feedback caused by a controller).

It should be noted that the controlled system Σₚ(⋅), the system model Σₘ(⋅) and the augmented system model Σ_{m,aug}(⋅) are generally represented/described by dynamic non-linear functions. The notation “(⋅)” is used to indicate that these non-linear functions depend on a plurality of input arguments, which are only mentioned for the sake of readability if this is necessary for understanding.

In the following, the notation Σ_{m,aug}(⋅) denotes the mathematical formulation of the (dynamic non-linear) augmented system model, which calculates the modeled controlled system output yₘ(k) (i.e., the value of the controlled variable y(k) calculated by the model) as a function of the manipulated variable u(k), the calculated and/or measured (and therefore known) disturbance variables zₘ(k) and the estimated deviation term/error term d(k), i.e.:

yₘ=Σ_{m,aug}(u,zₘ,d).

The notation

$${Σ}_{m , aug}^{- 1} ( \cdot )$$

denotes the formulation that calculates the manipulated variable u(k) as a function of the estimated deviation term/error term d(k), the calculated and/or measured (and therefore known) disturbance variables zₘ(k), the controlled variable y(k) and their time derivatives \dot{y}(k), ÿ(k), . . . , y⁽ⁿ⁾(k) (n is the system order of the system model Σₘ(⋅)), i.e.:

$$u = {Σ}_{m , aug}^{- 1} ( d , {z}_{m} , y , \dot{y} , … , {y}^{( n )} ) .$$

Preferably, the augmented system model Σ_{m,aug}(⋅) can be obtained by augmenting the system model Σₘ(⋅) of the controlled system Σₚ(⋅) in a model equation that models a physical power balance. This makes it possible to estimate/calculate the deviation term/error term in almost every model equation of the Σₘ(⋅) system model in an advantageous way. d(k) The deviation term/error term d(k) can advantageously extend the system model Σₘ(⋅) as an internal model variable (e.g. as an additive term, a multiplicative term, etc.).

As indicated in FIG. 1a, the following steps can be carried out in the non-limited mode m_{actuator,free}.
determining a setpoint of yₛₑₜ(k) a control variable y(k),
Determination of a desired value y_{des}(k) of the controlled variable y(k) and of time derivatives \dot{y}_{des}(k), ÿ_{des}(k), . . . ,

$${y}_{des}^{( n )}$$

(k) of the desired value y_{des}(k) up to a system order n of an augmented system model Σ_{m,aug}(⋅) of the controlled system Σₚ(⋅) as a function of the setpoint yₛₑₜ(k) of the control variable y(k) using a trajectory generator Σ_{des}(⋅), determining a requested manipulated variable u_{req}(k) of the actuator as a function of the desired value y_{des}(k) of the controlled variable y(k) and of time derivatives \dot{y}_{des}(k), ÿ_{des}(k), . . . ,

$${y}_{des}^{( n )}$$

$${Σ}_{m , aug}^{- 1} ( \cdot )$$

the controlled system Σₚ(⋅),
Set a limited setpoint y_{set,lim}(k) of the controlled variable y(k) equal to the specific setpoint yₛₑₜ(k) of the controlled variable y(k).

FIG. 1a (which shows the calculation in non-limited mode) is described in detail below. Here, the controller (i.e. actuator) is not saturated. The command signal/setpoint signal yₛₑₜ(k) goes into the trajectory generator Σ_{des}(⋅) (e.g. in the event that the system order of the system model is n=1, a PT1 filter could be used as the trajectory generator). The purpose of the trajectory generator Σ_{des}(⋅) is to calculate the so-called desired controlled variable y_{des}(k) (the desired value of the controlled variable y(k)) and the time derivatives \dot{y}_{des}(k), ÿ_{des}(k), . . . ,

$${y}_{des}^{( n )}$$

(k). The desired controlled variable y_{des}(k) and its time derivatives \dot{y}_{des}(k), ÿ_{des}(k), . . . ,

$${y}_{des}^{( n )}$$

(k) are then entered into the

$${\sum }_{m , aug}^{- 1} ( \cdot )$$

model (instead of y(k), \dot{y}(k), ÿ(k), . . . , y⁽ⁿ⁾(k)). In addition, the known/measurable disturbance variables zₘ(k) are included in the model

$${\sum }_{m , aug}^{- 1} ( \cdot )$$

and instead of the estimated deviation term/error term d(k) a so-called requested compensation term/correction term d_{req}(k) is included in the model

$${\sum }_{m , aug}^{- 1} ( \cdot ) .$$

Consequently, the so-called requested manipulated variable u_{req}(k) is calculated:

$${u}_{req} = {\sum }_{m , aug}^{- 1} ( {d}_{req} , {z}_{m} , {y}_{des} , {\dot{y}}_{d e s} , … , {y}_{des}^{( n )} ) .$$

In addition, the so-called limited setpoint y_{set,lim}(k) is set equal to the setpoint yₛₑₜ(k). The limited setpoint y_{set,lim}(k) is required by the switching logic in a switching device that switches between the calculation in non-limited mode (FIG. 1a) and limited mode (FIG. 1b) (see FIG. 2).

As indicated in FIG. 1b, the following steps can be performed in the limited mode m_{actuator,min}/m_{actuator,max}:
determining a limited manipulated variable uₗᵢₘ(k) of the actuator,
Determination of a desired value y_{des}(k) of the controlled variable y(k) and of time derivatives \dot{y}_{des}(k), ÿ_{des}(k), . . . ,

$${y}_{des}^{( n )}$$

(k) of the desired value y_{des}(k) up to a system order n of an augmented system model Σ_{m,aug}(⋅) of the controlled system Σₚ(⋅) as a function of the limited manipulated variable uₗᵢₘ(k) using the augmented system model Σ_{m,aug}(⋅),
determining a limited setpoint y_{set,lim}(k) of the controlled variable y(k) as a function of the desired value y_{des}(k) of the controlled variable y(k) and of time derivatives \dot{y}_{des}(k), ÿ_{des}(k), . . . ,

$${y}_{des}^{( n )}$$

(k) of the desired value y_{des}(k) using an inverted trajectory generator Σ_{des}(⋅),
setting a requested manipulated variable u_{req}(k) of the actuator equal to the limited manipulated variable uₗᵢₘ(k).

FIG. 1b (which shows the calculation in limited mode) is described in detail below. Here, the controller (i.e. actuator) is saturated. Depending on whether the controller is in the upper or lower stop (i.e. in the upper or lower saturation), the corresponding value (i.e. the respective saturation value) of the manipulated variable in the upper stop (i.e. the maximum manipulated variable) u_{req,max}(k) or in the lower stop (i.e. the minimum manipulated variable) u_{req,min}(k) is fed into the model Σ_{m,aug}(⋅) as a so-called limited manipulated variable uₗᵢₘ(k). Taking into account the inverted trajectory generator

$${\sum }_{des}^{- 1} ( \cdot ) ,$$

whose inputs are the desired controlled variable y_{des}(k) and its time derivatives \dot{y}_{des}(k), ÿ_{des}(k), . . . ,

$${y}_{des}^{( n )}$$

(k), the limited setpoint y_{set,lim}(k) is calculated.

The limited setpoint y_{set,lim}(k) therefore indicates which setpoint is reached with the limited manipulated variable uₗᵢₘ(k). In addition, the requested manipulated variable u_{req}(k) is set equal to the limited manipulated variable uₗᵢₘ(k) in limited mode.

In addition, it may be provided that a switching device (may also be referred to as a state machine) is provided to switch the operation of the controlled system Σₚ(⋅) between the first mode m_{actuator,free} and the second mode m_{actuator,min}/m_{actuator,max}. On the one hand, the switching device 10 can be used to compare a limited setpoint y_{set,lim}(k) of a controlled variable y(k) with a setpoint yₛₑₜ(k) of the controlled variable y(k) and, depending on the comparison, to determine whether the limited mode m_{actuator,min}/m_{actuator,max} can be exited and switched to the non-limited mode m_{actuator,free}. The switching device 10 can also be used to compare a requested manipulated variable u_{req}(k) of the actuator with the manipulated variable limitations u_{req,min}(k)/u_{req,max}(k) and, depending on the comparison, to determine whether it is necessary to switch from the non-limited mode m_{actuator,free}) to the limited mode m_{actuator,min}/m_{actuator,max}.

As shown in FIG. 2, the switching device or the state machine can determine the mode of the actuator m_{actuator}(k) which is used to switch between the calculation in FIG. 1a and the calculation in FIG. 1b. The state machine in FIG. 2 can have the states “Controller in lower saturation,” “Controller not in saturation” and “Controller in upper saturation.” The state machine can start in the “Controller in lower saturation” state. In this state, the mode of the controller m_{actuator}(k) is set to m_{actuator,min}, whereby m_{actuator,min} indicates that the controller is currently in the lower saturation. As long as the state machine is in the “Controller in lower saturation” state, the condition is checked in each time step k to see whether the limited setpoint y_{set,lim}(k) is greater than the setpoint yₛₑₜ(k). As long as this condition is not met, the state machine remains in the “Controller in low saturation” state. However, as soon as this condition is met, the state machine switches to the “Controller not in saturation” state. In this state, the mode of the actuator m_{actuator}(k) is set to m_{actuator,free}, whereby m_{actuator,free} indicates that the controller is not currently in saturation. As long as the state machine is in the “Controller not in saturation” state, two conditions are checked in each time step k. If the “requested” manipulated variable u_{req}(k) is greater than or equal to its (current) maximum value u_{req,max}(k), the state machine changes to the “Controller in upper saturation” state. If the “requested” manipulated variable u_{req}(k) is less than or equal to its (current) minimum value u_{req,min}(k), the state machine switches to the “controller in lower saturation” state. If neither of the two conditions is met, the state machine remains in the “Controller not in saturation” state. In the “Controller in upper saturation” state, the mode of the actuator m_{actuator}(k) is set to m_{actuator,max}, whereby m_{actuator,max} indicates that the controller is currently in upper saturation. As long as the state machine is in the “Controller in upper saturation” state, the condition is checked in each time step k to see whether the limited setpoint y_{set,lim}(k) is smaller than the setpoint yₛₑₜ(k). As long as this condition is not met, the state machine remains in the “Controller in upper saturation” state. However, as soon as this condition is met, the state machine switches to the “Controller not in saturation” state.

If the mode of the actuator m_{actuator}(k) is m_{actuator,min} or m_{actuator,max} (the state of the state machine in FIG. 2 is “Controller in lower saturation” or “Controller in upper saturation”), the calculation is performed as shown in the block diagram in FIG. 1b. In the event that m_{actuator}(k) is equal to m_{actuator,min}, the limited manipulated variable uₗᵢₘ(k) is set equal to the minimum manipulated variable u_{req,min}(k). In the event that m_{actuator}(k) is equal to m_{actuator,max}, the limited manipulated variable uₗᵢₘ(k) is set equal to the maximum manipulated variable u_{req,max}(k). However, if the mode of the actuator m_{actuator}(k) is m_{actuator,free} (the state of the state machine in FIG. 2 is “Controller not in saturation”), the calculation is carried out as in the block diagram in FIG. 1a.

A corresponding computer program, a corresponding controller 100, and a corresponding energy converter (not shown in full for reasons of simplicity) also constitute aspects of the invention.

The preceding description of the embodiments describes the present invention exclusively in the context of examples. Of course, individual features of the embodiments can be freely combined with one another, provided that this is technically meaningful, without departing from the scope of the present invention.

1. A method for model-based operation of a controlled system (Σₚ(⋅)) in the form of a subsystem of a coolant system for operating an electrochemical energy converter,
the method comprising:
determining a state (m_{actuator}(k)) of an actuator of the controlled system (Σₚ(⋅)) based on manipulated variable limitations (u_{req,min}(k)/u_{req,max}(k))) of the actuator, and
operating the controlled system (Σₚ(⋅)) depending on the state (m_{actuator}(k)) of the actuator.

2. The method according to claim 1, wherein
at least two modes for operating the controlled system (Σₚ(⋅)) are provided depending on the state (m_{actuator}(k)) of the actuator:
a non-limited mode ((m_{actuator,free}), in which the actuator can provide a requested manipulated variable (u_{req}(k)) without restriction,
a limited mode (m_{actuator,min}/m_{actuator,max}) in which the actuator can provide a requested manipulated variable (u_{req}(k)) restricted by at least one manipulated variable limitation (u_{req,min}(k)/u_{req,max}(k)).

3. The method according to claim 2, wherein
the following steps are performed in the non-limited mode (m_{actuator,free}):
determining a setpoint (yₛₑₜ(k)) of a control variable (y(k)),
determining a desired value (y_{des}(k)) of the controlled variable (y(k)) and of time derivatives (\dot{y}_{des}(k), ÿ_{des}(k), . . . ,
$${y}_{des}^{( n )}$$
(k)) of the desired value (y_{des}(k)) up to a system order (n) of an augmented system model (Σ_{m,aug}(⋅)) of the controlled system (Σₚ(⋅)) as a function of the setpoint (yₛₑₜ(k)) of the control variable (y(k)) using a trajectory generator (Σ_{des}(⋅)),
determining a requested manipulated variable (u_{req}(k)) of the actuator as a function of the desired value (y_{des}(k)) of the controlled variable (y(k)) and of time derivatives (\dot{y}_{des}(k), ÿ_{des}(k), . . . ,
$${y}_{des}^{( n )}$$
(k)) of the desired value (y_{des}(k)) using an inverted augmented system model
$$( {\sum }_{m , aug}^{- 1} ( \cdot ) )$$
of the controlled system (Σₚ(⋅)), and
setting a limited setpoint (y_{set,lim}(k)) of the controlled variable (y(k)) equal to the specific setpoint (yₛₑₜ(k)) of the controlled variable (y(k)).

4. The method according to claim 2, wherein
the following steps are performed in the limited mode (m_{actuator,min}/m_{actuator, max}):
determining a limited manipulated variable (uₗᵢₘ(k)) of the actuator,
determining a desired value (y_{des}(k)) of the controlled variable (y(k)) and of time derivatives (\dot{y}_{des}(k), ÿ_{des}(k), . . . ,
$${y}_{des}^{( n )}$$
(k)) of the desired value (y_{des}(k)) up to a system order (n) of an augmented system model (Σ_{m,aug}(⋅)) of the controlled system (Σₚ(⋅)) as a function of the limited manipulated variable (uₗᵢₘ(k)) using the augmented system model (Σ_{m,aug}(⋅)),
determining a limited setpoint (y_{set,lim}(k)) of the controlled variable (y(k)) as a function of the desired value (y_{des}(k)) of the controlled variable (y(k)) and of time derivatives (\dot{y}_{des}(k), ÿ_{des}(k), . . . ,
$${y}_{des}^{( n )}$$
(k)) of the desired value (y_{des}(k)) using an inverted trajectory generator
$$( {\sum }_{des}^{- 1} ( \cdot ) ) ,$$
and
setting a requested manipulated variable (u_{req}(k)) of the actuator equal to the limited manipulated variable (uₗᵢₘ(k)).

5. Method according to claim 2, wherein
a switching device (10) is provided to switch the operation of the controlled system (Σₚ(⋅)) between the non-limited mode (m_{actuator,free}) and the limited mode (m_{actuator,min}/m_{actuator,max}),
wherein the switching device (10) serves to compare a limited setpoint value (y_{set,lim}(k)) of a controlled variable (y(k)) with a setpoint value (yₛₑₜ(k)) of the controlled variable (y(k)) and, depending on the comparison, to determine whether the limited mode (m_{actuator,min}/m_{actuator,max}) can be exited and switched to the non-limited mode (m_{actuator,free}), and/or wherein the switching device (10) serves to compare a requested manipulated variable (u_{req}(k)) of the actuator with the manipulated variable limitations (u_{req,min}(k)/u_{req,max}(k)) and, depending on the comparison, to determine whether it is necessary to switch from the non-limited mode (m_{actuator,free}) to the limited mode (m_{actuator,min}/m_{actuator,max}).

6. The method according to claim 1, wherein
an augmented system model (Σ_{m,aug}(⋅)) is obtained by augmenting the system model (Σₘ(⋅)) of the controlled system (Σₚ(⋅)) in a model equation that models a physical power balance.

7. The method according to claim 1, wherein
the controlled system (Σₚ(⋅)) includes a fuel cell stack,
and a coolant outlet temperature from a fuel cell stack is used as the control variable (y(k)).

8. The method according to claim 1, wherein
the controlled system (Σₚ(⋅)) includes a mixing point of a coolant system,
and a coolant inlet temperature into a fuel cell stack is used as the control variable (y(k)).

9. The method according to claim 1, wherein
the controlled system (Σₚ(⋅)) includes a cooler of a coolant system,
and a coolant outlet temperature from a cooler is used as the control variable (y(k)).

10. (canceled)

11. A non-transitory, computer-readable medium containing instructions that when executed by a computer, cause the computer to control a controlled system (Σₚ(⋅)) in the form of a subsystem of a coolant system for operating an electrochemical energy converter, by
determining a state (m_{actuator}(k)) of an actuator of the controlled system (Σₚ(⋅)) based on manipulated variable limitations (u_{req,min}(k)/u_{req,max}(k))) of the actuator, and
operating the controlled system (Σₚ(⋅)) depending on the state (m_{actuator}(k)) of the actuator.

12. A controller (100), comprising a memory unit in which a code is stored, and a computer, wherein when the code is executed by the computer to control a controlled system (Σₚ(⋅)) in the form of a subsystem of a coolant system for operating an electrochemical energy converter, by
determining a state (m_{actuator}(k)) of an actuator of the controlled system (Σₚ(⋅)) based on manipulated variable limitations (u_{req,min}(k)/u_{req,max}(k))) of the actuator, and
operating the controlled system (Σₚ(⋅)) depending on the state (m_{actuator}(k)) of the actuator.

13. An electrochemical energy converter in the form of a fuel cell stack of a fuel cell system comprising a controller (100) according to claim 12.
